(19) United States
(12) Patent Application Publication
(10) Pub. No.: US 2024/0077653 A1
(43) Pub. Date: Mar. 7, 2024

(54) Radiative Cooling Structure and Manufacturing Method

(71) Applicant: Jordan Fourcher, Mesa, AZ (US)

(72) Inventor: Jordan Fourcher, Mesa, AZ (US)

(21) Appl. No.: 17/901,750

(22) Filed: Sep. 1, 2022

(51) Int. Cl. G02B 1/14; G02B 5/20; G02B 5/26

(52) U.S. Cl. CPC G02B 1/14; G02B 5/206; G02B 5/208; G02B 5/26

(57) ABSTRACT

The present invention relates to a radiative cooling structure and a method for manufacturing the radiative cooling structure. The radiative cooling structure comprises a reflective layer and a protective layer. The protective layer having a recessed portion and outer edges. The outer edges extend vertically on the reflective layer towards a target surface. The outer edges abut the target surface to seal the reflective layer. A bonding material abuts the protective layer to the target surface. Thereby, prolonging the shelf life of the reflective layer.

### TECHNICAL FIELD OF THE INVENTION

The present invention relates to radiative cooling, and more particularly to a radiation cooling structure and a method of manufacturing a radiative cooling structure to prolong the durability of a radiative cooling material.

### BACKGROUND OF THE INVENTION

This section describes the technical field in detail and discusses problems encountered in the technical field. Therefore, statements in the section are not to be construed as prior art.

Objects placed outdoors absorb solar energy from the sun. Due to the solar heat absorption, the temperature of the objects placed outside increased continuously. The increased temperature reduces the shelf life of the object.

To reduce the temperature of external objects, cooling has become a critical concern. To overcome the issue, various radiative cooling systems and methods are used. The radiative cooling system and methods use radiative cooling technology to lower the object's temperature. The radiative cooling technology comprises a radiative cooling material attached to the top of the object. The radiative cooling material reflects the solar energy to the outer environment. Thereby, achieving electricity-free spontaneous cooling.

But radiative cooling requires specific materials and structures to prevent solar heating. It increases the overall cost of the system. Also, the conventional system exposes the radiative cooling material directly to the outer environment without any covering. Direct exposure cooling to the outer atmosphere or regular cleaning of the radiative material declines its efficacy and service life. Many prior art methods suggest covering radiative cooling material to prevent it from damage. The covering material used for protecting the radiative cooling materials is not durable. However, covering disrupt the microscopic configuration of the radiative cooling material, resulting in poor performance.

Therefore, there is a need for a radiative cooling structure or method that prolongs the durability of the radiative cooling material.

### SUMMARY OF THE INVENTION

The object is solved by independent claims, and embodiments and improvements are listed in the dependent claims. Hereinafter, what is referred to as “aspect”, “design”, or “used implementation” relates to an “embodiment” of the invention and when in connection with the expression “according to the invention”, which designates steps/features of the independent claims as claimed, designates the broadest embodiment claimed with the independent claims.

An object of the present invention is to provide a radiative cooling structure deposited on a target surface to reduce the temperature.

Another object of the present invention is to provide a radiative cooling structure comprising a reflective layer to reflect radiation in at least one portion of the solar spectrum. The reflective layer comprises a radiative cooling material. The radiative cooling material has high emissivity in a sky window than conventionally available methods.

Another object of the present invention is to provide a flexible radiative cooling structure.

Another object of the present invention is to provide a radiative cooling structure comprising a protective layer to reduce the effect of foreign substances on a reflective layer.

Another object of the present invention is to provide a unique radiative cooling structure to seal the reflective layer. It eliminates the effect of foreign conditions on the reflective layer and increases the life span of the reflective layer.

Another object of the invention is to provide a radiative cooling structure that cools a target surface below a sub-ambient temperature.

Another object of the present invention is to provide a universally compatible radiative cooling structure to reduce the overall cost of the product.

According to an aspect of the present invention, the present invention provides a radiative cooling structure. The radiative cooling structure comprises a reflective layer and a protective layer. The protective layer comprises a recessed inner portion and outer edges. The outer edges of the protective layer extend vertically on the reflective layer towards a target surface. The outer edges abut the target surface to seal the reflective layer. A bonding material abuts the protective layer to the target surface. The protective layer seals the reflective layer, creating an air gap between the reflective layer and the protective layer. Thickness of the reflective layer is less than or equal to thickness of the recessed portion of the protective layer. The protective layer consists of at least one thermoplastic polymer material.

In an embodiment, according to the present invention, the reflective layer is formed of a radiative cooling material. The radiative cooling material can comprise silver, platinum, aluminium, silver alloy, calcium carbonate, silica dioxide, silicon carbide, zinc oxide, titanium dioxide, aluminium oxide, magnesium oxide, barium sulfate, polytetrafluoroethylene, gold, copper, zinc, or a combination thereof.

In an embodiment, according to the present invention, the reflective layer comprises one or more types of nanoparticles. Each type of nanoparticle has higher emissivity in at least one portion of the solar spectrum.

In an embodiment, according to the present invention, the reflective layer reflects radiation in at least one portion of the solar spectrum when placed in a direct line of sight to space. The reflective layer reduces the temperature of the radiative cooling structure by 15° F.

In an embodiment, according to the present invention, the bonding material is glue, urethane, ethylene vinyl acetate, acrylic, or any other bonding material.

In an embodiment, according to the present invention, the target surface is glass windows, floor tiles, roof tiles, solar panels, mobile phones, vehicles, and other electronic equipments, but not limited to.

In an alternative embodiment, the reflective layer is applied to a thin film layer. The thin film layer comprises an etched inner portion and outer ends.

According to another aspect of the present invention, the present invention provides a method of manufacturing a radiative cooling structure. The radiative cooling structure comprises a reflective layer and a protective layer. A reflective layer is formed using suitable technology/methods. The protective layer is etched to create a recessed portion and outer edges. The outer edges extend vertically on the reflective layer towards a target surface. The protective layer is deposited over the reflective layer. The outer edges abut the target surface to seal the reflective layer. A bonding material abuts the protective layer to the target surface.

The protective layer seals the reflective layer, creating an air gap between the reflective layer and the protective layer. The thickness of the reflective layer is less than or equal to a thickness of the recessed portion of the protective layer. The protective layer is formed of at least one thermoplastic polymer material.

In an embodiment, according to the present invention, the protective layer is etched by dry etching, wet etching, or any other suitable method.

In an embodiment, according to the present invention, the reflective layer is formed of a radiative cooling material. The radiative cooling material is silver, platinum, silver alloy, calcium carbonate, silica dioxide, silicon carbide, zinc oxide, titanium dioxide, aluminium oxide, magnesium oxide, barium sulfate, polytetrafluoroethylene, gold, copper, zinc, aluminium, or a combination thereof.

In an embodiment, according to the present invention, the reflective layer comprises one or more types of nanoparticles, wherein each type of nanoparticle has higher emissivity in at least one portion of the solar spectrum.

In an embodiment, according to the present invention, the reflective layer is deposited by electroplating, thermal vapor deposition, electron-beam deposition, a sputtering deposition technique, or any other suitable method.

In an embodiment, according to the present invention, the protective layer is etched by dry etching, wet etching, or any other suitable method.

In an embodiment, according to the present invention, the bonding material is glue, urethane, ethylene vinyl acetate, acrylic, or any other bonding material.

In an embodiment, according to the present invention, the target surface is glass windows, floor tiles, roof tiles, solar panels, mobile phones, vehicles, and other electronic equipment, but not limited to.

In an alternative embodiment, the reflective layer is deposited on a thin film layer. The thin film layer comprises an etched inner portion and outer ends.

### BRIEF DESCRIPTION OF THE DRAWINGS

Various aspects, as well as embodiments of the present invention, are better understood by referring to the following detailed description. To better understand the invention, the detailed description should be read in conjunction with the drawings.

FIG. 1 is a schematic illustration of a radiative cooling structure in accordance with an embodiment of the present invention.

FIG. 2 is a schematic illustration of a radiative cooling structure including nanoparticles in accordance with an embodiment of the present invention.

FIG. 2(a) is a schematic geometric illustration of a radiative cooling structure in accordance with an alternative embodiment of the present invention.

FIG. 3(a) illustrates an arrangement of multiple recessed portions provided on a surface of a protective layer, forming a radiative cooling structure in accordance with an embodiment of the present invention.

FIG. 3(b) illustrates an inclined shape of a recessed portion provided on a surface of a protective layer, forming a radiative cooling structure in accordance with an embodiment of the present invention.

FIG. 3(c) illustrates a C-shape of a recessed portion provided on a surface of a protective layer, forming a radiative cooling structure in accordance with an embodiment of the present invention.

FIG. 4(a) illustrates a schematic illustration of a radiative cooling structure in accordance with an alternate embodiment of the present invention.

FIG. 4(b) illustrates an inclined shape of an etched inner portion provided on a surface of a thin film layer, forming a radiative cooling structure in accordance with an alternate embodiment of the present invention.

FIG. 4(c) illustrates a C-shape of an etched inner portion provided on a surface of a thin film layer, forming a radiative cooling structure in accordance with an alternate embodiment of the present invention.

FIG. 4(d) illustrates an arrangement of multiple etched inner portions provided on a surface of a thin film layer, forming a radiative cooling structure in accordance with an alternate embodiment of the present invention.

FIG. 5 illustrates a radiative cooling of a target surface using a radiative cooling structure in accordance with an embodiment of the present invention.

FIG. 6 illustrates a flowchart of manufacturing a radiative cooling structure in accordance with an embodiment of the present invention.

### DETAILED DESCRIPTION OF THE INVENTION

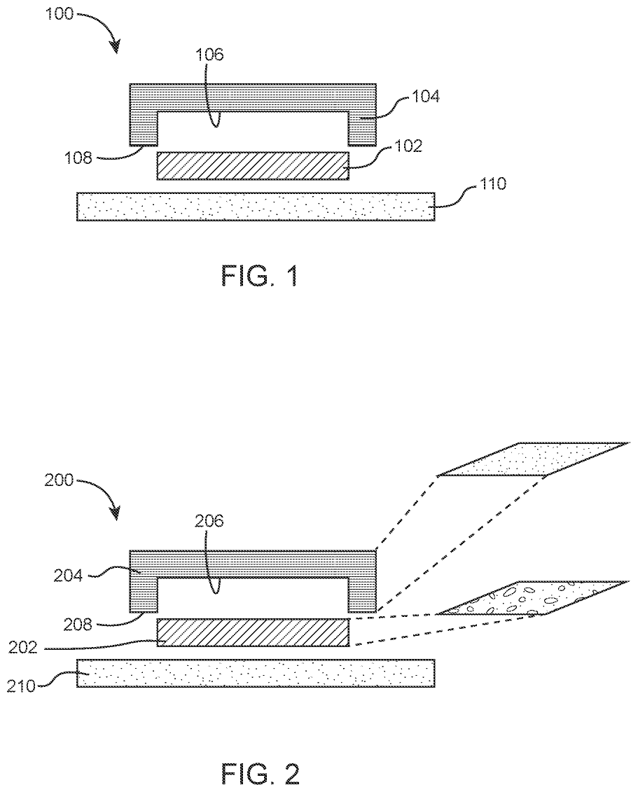

FIG. 1 is a schematic illustration of a radiative cooling structure 100 in accordance with an embodiment of the present invention. The radiative cooling structure 100 comprises a reflective layer 102 and a protective layer 104. The radiative cooling structure 100 includes multiple layers in a stacked structure.

The reflective layer 102 is composed of a radiative cooling material. The radiative cooling material is at least one metal material of silver, aluminium, platinum, silver alloy, calcium carbonate, silica dioxide, silicon carbide, zinc oxide, titanium dioxide, aluminium oxide, magnesium oxide, barium sulfate, polytetrafluoroethylene, gold, copper, zinc, or a combination thereof, but is not limited to.

The protective layer 104 comprises a recessed portion 106 and outer edges 108. The outer edges 108 extend vertically from the protective layer 104. The protective layer 104 is placed over the reflective layer 102. The outer edges 108 of the protective layer 104 abut a target surface 110 to seal the reflective layer 102. The protective layer 104 seals the reflective layer 102, creating an air gap between the reflective layer 102 and the protective layer 104. The protective layer 104 is formed of at least one thermoplastic polymer. The thermoplastic polymer is acrylic, polycarbonate, or any other durable transparent plastic material.

A bonding material abuts the protective layer 104 to the target surface 110. The bonding material is glue, urethane, ethylene vinyl acetate, acrylic, or other bonding material.

The target surface is glass windows, floor tiles, roof tiles, solar panels, mobile phones, vehicles, and other electronic equipment, but not limited to.

Alternatively, the reflective layer 102 is applied on a thin film layer. The thin film layer further comprises an etched inner portion and outer ends.

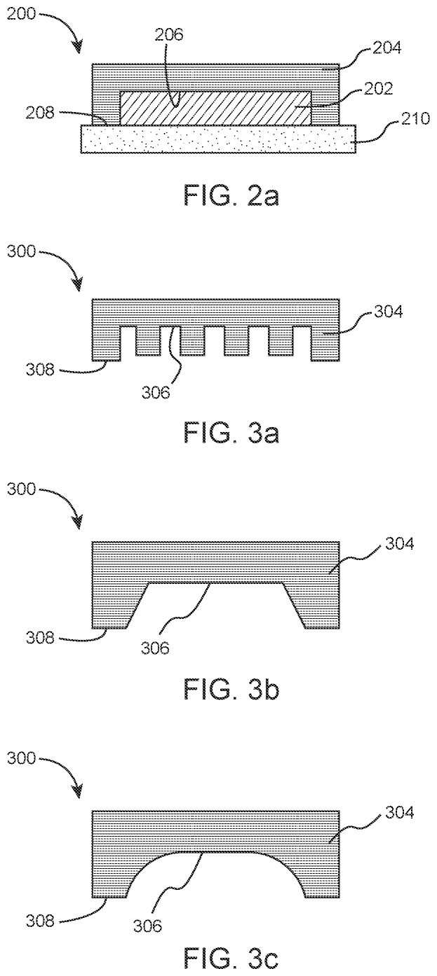

FIG. 2 is a schematic illustration of a radiative cooling structure 200 including nanoparticles in accordance with an embodiment of the present invention. The radiative cooling structure 200 comprises a reflective layer 202 and a protective layer 204.

The radiative cooling structure 200 is in sheet or film form. The sheet may have a width or length on the scale of centimeters or meters. Thickness of the reflective layer 202 is less than thickness of the recessed portion 206 of the protective layer 204.

Alternatively, the reflective layer 202 is formed by stacking multiple thin layers. The multiple thin layers consist of two different radiative cooling materials. The multiple thin layers may have the same or different thicknesses. The different radiative cooling materials are capable of reflecting radiation effectively in at least one portion of the solar spectrum. As the thickness of the reflective layer 202 increases, radiation reflectivity increases accordingly. Thereby, achieving superior cooling performance.

The reflective layer 202 consists of a reflective cooling material. The reflective layer 202 comprises one or more types of nanoparticles. Each type of nanoparticle has high emissivity to a particular portion of the solar spectrum. Size, materials, and mass ratio of the components of the reflective layer 202, i.e. polymer and the nanoparticles, are selected accordingly to achieve the desired performance. Smaller nanoparticles having diameters of less than 100 nm are used.

As the content of the nanoparticles in the reflective layer 202 increases, the solar reflectivity also increases.

The size and the configuration of the nanoparticles included in the reflective layer 202 plays a significant role in achieving superior performance. As the size of the nanoparticles decreases, the solar reflectivity increases.

Alternatively, the reflective layer 202 may be formed of a mixture of fine particles and a polymer. The fine particles may be formed of an oxide or a nitride and include, for example, at least one of silica, zirconium oxide, alumina, titanium dioxide, silicon nitride, or a combination thereof. The fine particles may have a diameter of 10 nm to 20 μm. The fine particles having a nanometer-scale diameter may have higher mid-infrared emissivity than the fine particles having a micrometer-scale diameter.

The polymer may be made of an acrylic polymer such as polydimethylsiloxane or dipentaerythritol penta/hexa acrylate without being limited thereto.

Based on a total weight of the mixture, 1% by weight to 20% by weight of the fine particles may be mixed with the polymer.

The reflective layer 202 used for reflecting at least one portion of the solar spectrum works with any type of base material.

The protective layer 204 is placed on the reflective layer 202. The protective layer 204 is etched to create a recessed portion 206 and outer edges 208. The outer edges 208 extend vertically from the protective layer 204. The outer edges 208 of the protective layer 204 abut a target surface 210 to seal the reflective layer. It creates an air gap between the protective layer 204 and the reflective layer 202. Thereby, preventing the damage of the reflective layer 202 in the outdoor environment. This prolongs the service life of the radiative cooling material. The complete enclosure of the radiative cooling material makes it easy to clean.

The recessed portion 206 and the outer edges 208 are formed using a wet etching method or a dry method, but not limited to. Exemplary wet methods include such known methods as so-called metal plating (electroless plating or electroplating). Exemplary dry methods include vacuum evaporation, sputtering, and ion plating.

The target surface is glass windows, floor tiles, roof tiles, solar panels, mobile phones, vehicles, and other electronic equipment, but not limited to.

The protective layer 204 is formed of at least one thermoplastic polymer. The thermoplastic polymer is acrylic, polycarbonate, or any other durable transparent plastic material.

Alternatively, the shape and size of the recessed portion 206 are formed based on the applicability.

Alternatively, the protective layer 204 comprises one or more types of nanoparticles. The nanoparticles include silicon nitride, aluminium oxide, silicon dioxide, calcium carbonate, and/or a combination thereof. The use of nanoparticles increases emissivity in the thermal radiation range. The use of nanoparticles enhances the emissivity of the protective layer 204 in the thermal spectrum.

Alternatively, the protective layer 204 with nanoparticles has thickness of about 5 μm to 10 μm.

The protective layer 204 laminates the reflective layer 202 sealed in the recessed portion 206 and the outer edges 208. The protective layer 204 serves as a transparent window to pass the sunlight to the reflective layer 202. The protective layer 204 has significantly less reflectivity and absorption. The protective layer 204 covers the reflective layer 202 to prevent direct exposure to moisture and air.

The reflective layer 202 and the protective layer 204 are deposited over the target surface by electroplating, physical or chemical vapor deposition, photolithography, thermal vapor deposition, electron-beam deposition, 3D printing, imprinting, spraying, dip-coating, spin-coating, or using an applicator, a sputtering deposition technique, or any other suitable method.

FIG. 2(a) is a schematic geometric illustration of a radiative cooling structure 200 in accordance with an alternative embodiment of the present invention. The radiative cooling structure 200 comprises a reflective layer 202 and a protective layer 204. The protective layer 204 further comprises a recessed portion 206 and outer edges 208. The outer edges 208 extend vertically from the protective layer 204. The protective layer 204 is placed over the reflective layer 202. The outer edges 208 of the protective layer 204 abut a target surface 210 to seal the reflective layer 202. The protective layer 204 is formed of at least one thermoplastic polymer. The thermoplastic polymer is acrylic, polycarbonate, or any other durable transparent plastic material.

Thickness of the reflective layer 202 is equal to thickness of the protective layer 204.

A bonding material abuts the protective layer 204 to the target surface. The bonding material is glue, urethane, ethylene vinyl acetate, acrylic, or other bonding material.

FIG. 3(a) illustrates an arrangement of multiple recessed portions 306 and outer edges 308 provided on a surface of a protective layer 304 forming a radiative cooling structure 300 in accordance with an embodiment of the present invention. FIG. 3(a) illustrates multiple U-type recessed portions 306. The recessed portions 306 are arranged in a sequential manner. The actual size of the recessed portion 306 is greater than the size shown in the figures. The shape of the recessed portion 306 is not fixed. The shape of the recessed portions 306 can be varied as per application area or applicability. Alternatively, the shape of the recessed portions 306 can be triangular, polygon, square, but not limited to.

FIG. 3(b) illustrates an inclined shape of a recessed portion 306 provided on the surface of a protective layer 304 forming a radiative cooling structure 300 in accordance with an embodiment of the present invention. The protective layer 304 is etched at a specific angle to form a recessed portion 306 and the outer edges 308.

FIG. 3(c) illustrates a C-shape of a recessed portion 306 provided on a surface of a protective layer 304 forming a radiative cooling structure 300 in accordance with an embodiment of the present invention. The protective layer 304 is etched to form a C-shape recessed portion 306 and outer edges 308.

The different shapes of the recessed portion 306 stated above create a room for the reflective layer. The different shapes of the recessed portion 306 are selected based on the applicability or application area. FIG. 3(b) and FIG. 3(c) shows a single recessed portion 306. Alternatively, multiple inclined shapes and C-shapes recessed portions 306 can be formed.

The recessed portion 306 and the outer edges 308 are formed using a wet etching method or a dry method, but not limited to. Exemplary wet methods include such known methods as so-called metal plating (electroless plating or electroplating). Exemplary dry methods include vacuum evaporation, sputtering, and ion plating.

The primary purpose of forming the radiative cooling structure 300 is to prolong the durability of the reflective layer by enclosing it with the protective layer 304.

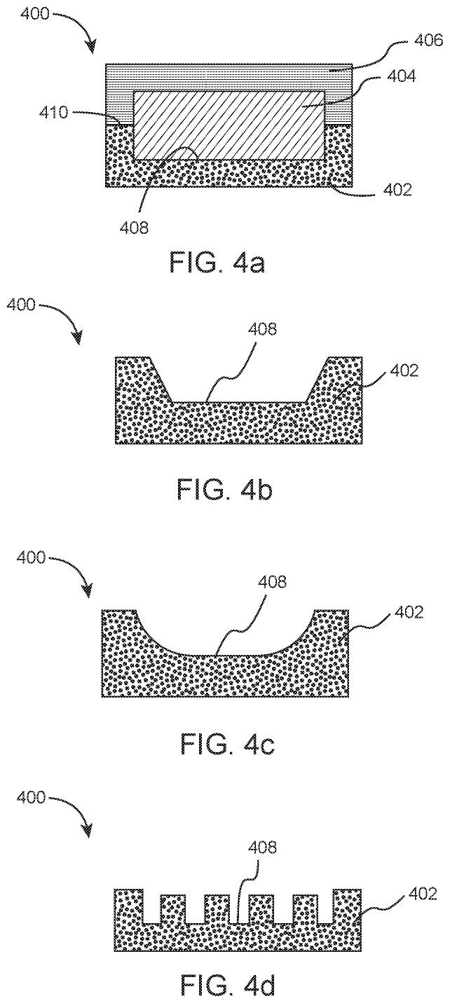

FIG. 4(a) illustrates a schematic illustration of a radiative cooling structure 400 in accordance with an alternate embodiment of the present invention. The radiative cooling structure 400 comprises a thin film layer 402, a reflective layer 404, and a protective layer 406. The radiative cooling structure 400 includes multiple layers in a stacked structure.

The thin film layer 402 forms a base of the radiative cooling structure 400 for other layers 404 and 406. The other layers 404 and 406 are formed on the surface of the thin film layer 402 by using different methods/technologies. The other layers, 404 and 406, are formed in multiple steps using a suitable technology or process. The layers 404 and 406 formed in different steps and layered together to deposit over the thin film layer 402.

The thin film layer 402 is formed of a flexible material. The flexible material is formed of flexible polymer film, glass, quartz, silicon wafer, metal, polyester-based resins such as polyethylene naphthalate, acetate-based resins, polyethersulfone-based resins, polycarbonate-based resins, polyamide-based resins, polyimide-based resins, polyolefin-based resins, (meth)acrylic resins, polyvinyl chloride-based resins, polyvinylidene chloride-based resins, polystyrene-based resins, polyvinyl alcohol-based resins, polyarylate-based resins, and polyphenylene sulfide-based resins, but is not limited to. A flexible thin film layer is used to mount on uneven-shaped target surfaces.

Alternatively, the thin film layer 402 is formed of a rigid material. The rigid material is formed of silicon dioxide, calcium carbonate, and aluminium oxide but is not limited to. A rigid material is used to mount on hard surfaces to provide radiative cooling.

The thin film layer 402 is etched to form an etched inner portion 408 and outer ends 410. The etched inner portion 408 receives the reflective layer 404. The etched inner portion 408 holding the reflective layer 404 has a different refractive index than the rest of the thin film layer 402. The protective layer 406 is etched in the same way as the reflective layer 404. The protective layer 406 abuts the thin film layer 402 to seal the reflective layer 404. Thickness of the reflective layer 404 is equal to the sum of thickness of the etched inner portion 408 and the etched portion of the protective layer.

Alternatively, the shape of the etched inner portion 408 of the thin film layer 402 is an inclined shape, but is not limited to, as shown in FIG. 4(b).

Alternatively, the shape of the etched inner portion 408 of the thin film layer 402 is C-shape, but is not limited to, as shown in FIG. 4(c).

Alternatively, the thin film layer 402 may comprise multiple etched inner portions 408, as shown in FIG. 4(d).

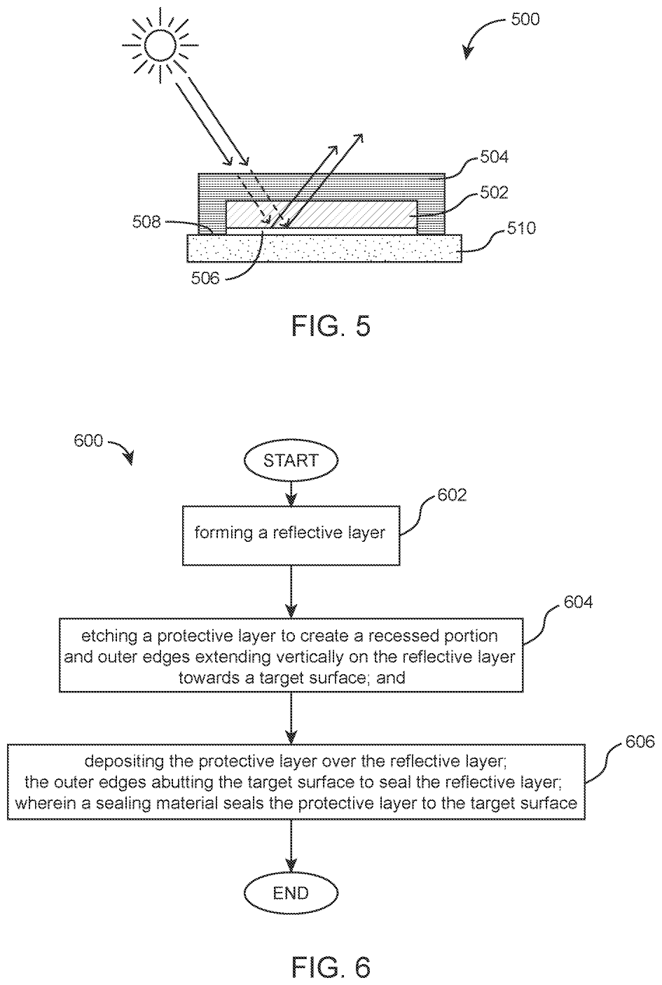

FIG. 5 illustrates a radiative cooling of a target surface 510 using a radiative cooling structure 500 in accordance with an embodiment of the present invention. The radiative cooling structure 500 is mounted on the target surface 510. The radiative cooling structure 500 comprises a reflective layer 502 and a protective layer 504. The protective layer 504 comprises a recessed portion 506 and outer edges 508 (briefly explained above in FIG. 1 and FIG. 2). The outer edges 508 extend vertically from the protective layer 504.

The radiative cooling structure 500 is mounted on the target surface 510. The radiation direct from the sun incident on the radiative cooling structure 500. The protective layer 504, the top layer of the radiative cooling structure, transverse the solar radiation to the below reflective layer 502. The protective layer 504 is a transparent layer with less absorption and emissivity. The solar radiation strikes at the enclosed reflective layer 502 and reflected back to the outer environment. The reflective layer 502 is formed of a radiative cooling material. The radiative cooling material further includes nanoparticles. Each nanoparticle has a specific size and specific micro configuration (briefly explained in FIG. 2). The specific micro configuration enables the radiative cooling structure 500 to reflect the solar radiation to the outer environment. The cooling effect comes from two aspects: 1) a large amount (e.g., ≥90%) of incident solar radiation can be reflected by the radiative cooling structure's 500 reflective layer 502, which greatly reduces the heat gain from solar radiation; 2) infrared radiative emission (e.g., ≥100 W/m2) from the radiative cooling structure 500 to the outer environment. This enables the reflective layer 502 to reduce the sub-ambient temperature by 15° F.

The reflective layer 502 reflects radiation in at least one portion of the solar spectrum when placed in a direct line of sight to space. Preferably, the reflective layer 502 reflects the infrared radiation to the outer environment.

The radiative cooling structure 500 manufacturing method is scalable. The radiative cooling structure 500 is scalable from small sizes to large sizes without changing the method.

The reflective layer 502 is formed of radiative cooling material. The radiative cooling material is available in its fragile form. To protect the radiative cooling material from water and air, the durable transparent protective layer 504 encloses the reflective layer 502. The weatherproofed transparent protective layer 504 prolongs the durability of the reflective layer 502.

FIG. 6 illustrates a flowchart of manufacturing a radiative cooling structure 600 in accordance with an embodiment of the present invention comprising the following steps: (a) forming a reflective layer (602); (b) etching (604) a protective layer to create a recessed portion and outer edges extending vertically on the reflective layer towards a target surface (c) depositing (606) the protective layer over the reflective layer; the outer edges abut the target surface to seal the reflective layer; wherein the bonding material abuts the protective layer to the target surface.

The reflective layer is made up of a radiative cooling material. The radiative cooling material is least one metal material of silver, aluminium, platinum, silver alloy, calcium carbonate, silica dioxide, silicon carbide, zinc oxide, titanium dioxide, aluminium oxide, magnesium oxide, barium sulfate, polytetrafluoroethylene, gold, copper, zinc, or a combination thereof, but is not limited to.

The reflective layer comprises one or more types of nanoparticles. Each type of nanoparticle has higher emissivity in at least one portion of the solar spectrum.

Thickness of the reflective layer is less than or equal to thickness of the recessed portion of the protective layer.

The reflective layer is deposited by using electroplating, physical or chemical vapor deposition, photolithography, thermal vapor deposition, electron-beam deposition, 3D printing, imprinting, spraying, dip-coating, spin-coating, or using an applicator, a sputtering deposition technique, or any other suitable method.

The protective layer is etched using dry etching, wet etching, or any other suitable method.

The protective layer is formed of at least one thermoplastic polymer. The thermoplastic polymer is acrylic, polycarbonate, or any other durable transparent plastic material.

The bonding material is glue, urethane, ethylene vinyl acetate, acrylic, or other bonding material.

The target surface is glass windows, floor tiles, roof tiles, solar panels, mobile phones, vehicles, and other electronic equipment, but not limited to.

Alternatively, the reflective layer is deposited over a thin film layer. The thin film layer further comprises an etched inner portion and outer ends.

The descriptions are merely example implementations of this application but are not intended to limit the protection scope of this application. A person with ordinary skills in the art may recognize substantially equivalent structures or substantially equivalent acts to achieve the same results in the same manner or in a dissimilar manner; the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. A function or an act should be interpreted as incorporating all modes of performing the function or act unless otherwise explicitly stated. For instance, layer depositing may be performed by using electron beam deposition or thermal vapor deposition. Therefore, the use of the word “deposition” invokes “electron beam deposition” or “thermal vapor deposition” and all other modes of this word and similar words such as “depositing layers”.

The description is provided for clarification purposes and is not limiting. Words and phrases are to be accorded their ordinary, plain meaning, unless indicated otherwise.

1. A radiative cooling structure comprising:
a. a reflective layer;
b. a protective layer having a recessed portion with outer edges extending vertically on the reflective layer towards a target surface; and
c. the outer edges abutting the target surface to seal the reflective layer, wherein a bonding material abuts the protective layer to the target surface.

2. The radiative cooling structure according to claim 1, wherein the reflective layer is formed of silver, aluminium, platinum, silver alloy, calcium carbonate, silica dioxide, silicon carbide, zinc oxide, titanium dioxide, aluminium oxide, magnesium oxide, barium sulfate, polytetrafluoroethylene, gold, copper, zinc or a combination thereof.

3. The radiative cooling structure according to claim 1, wherein the reflective layer comprises one or more types of nanoparticles, wherein each type of nanoparticle has higher emissivity in at least one portion of the solar spectrum.

4. The radiative cooling structure according to claim 1, wherein thickness of the reflective layer is less than or equal to thickness of the recessed portion of the protective layer.

5. The radiative cooling structure according to claim 1, wherein the reflective layer reflects radiation in at least one portion of the solar spectrum when placed in a direct line of sight to space.

6. The radiative cooling structure according to claim 1, wherein the reflective layer reduces the sub-ambient temperature of the radiative cooling structure by 15° F.

7. The radiative cooling structure according to claim 1, wherein a material of the protective layer comprises at least one thermoplastic polymer.

8. The radiative cooling structure according to claim 1, wherein the bonding material is glue, urethane, ethylene vinyl acetate, acrylic, or any other bonding material.

9. The radiative cooling structure according to claim 1, wherein the reflective layer applies to a thin film layer.

10. The radiative cooling structure according to claim 9, wherein the thin film layer having an etched inner portion with outer ends;

11. A method of manufacturing a radiative cooling structure comprising:
a. forming a reflective layer;
b. etching a protective layer to create a recessed portion and outer edges extending vertically on the reflective layer towards a target surface; and
c. depositing the protective layer over the reflective layer; the outer edges abutting the target surface to seal the reflective layer; wherein a bonding material abuts the protective layer to the target surface.

12. The method according to claim 11, wherein the reflective layer is formed of silver, aluminium, platinum, silver alloy, calcium carbonate, silica dioxide, silicon carbide, zinc oxide, titanium dioxide, aluminium oxide, magnesium oxide, barium sulfate, polytetrafluoroethylene, gold, copper, zinc, or a combination thereof.

13. The method according to claim 11, wherein the reflective layer comprises one or more types of nanoparticles, wherein each type of nanoparticle has higher emissivity in at least one portion of the solar spectrum.

14. The method according to claim 12, wherein thickness of the reflective layer is less than or equal to thickness of the recessed portion of the protective layer.

15. The method according to claim 11, wherein the reflective layer is deposited by electroplating, thermal vapor deposition, electron-beam deposition, a sputtering deposition technique, or any other suitable method.

16. The method according to claim 11, wherein the protective layer is etched by dry etching, wet etching, or any other suitable method.

17. The method according to claim 11, wherein a material of the protective layer comprises at least one thermoplastic polymer.

18. The method according to claim 11, wherein the bonding material is glue, urethane, ethylene vinyl acetate, acrylic, or any other bonding material.

19. The radiative cooling structure according to claim 11, wherein the reflective layer is applied to a thin film layer.

20. The radiative cooling structure according to claim 19, wherein the thin film layer having an etched inner portion with outer ends.
